(19) United States
(12) Patent Application Publication
(10) Pub. No.: US 2019/0127998 A1
(43) Pub. Date: May 2, 2019

(54) HOLLOW TWO-POINT LEVER

(71) Applicant: Schwing GmbH, Herne (DE)

(72) Inventor: Thomas Jasniewicz, Hagen (DE)

(21) Appl. No.: 16/169,095

(22) Filed: Oct. 24, 2018

(30) Foreign Application Priority Data
Oct. 26, 2017 (DE) 10 2017 125 145.6

(51) Int. Cl. E04G 21/04; B66C 23/70; B66F 7/06

(52) U.S. Cl. CPC E04G 21/0463; E02F 3/3668; B66F 7/06; B66C 23/702

(57) ABSTRACT

A mast arm for a large-scale manipulator is disclosed. The mast arm includes a turntable rotatable about a vertical axis, a two-point lever enclosing at least one cavity, and a plurality of mast arm segments. The plurality of mast arm segments are pivotable at articulated joints about articulation axes relative to an adjacent mast arm segment or the turntable via a respective drive unit. At least one of the respective drive units is fastened to a first mast arm segment and acts via the two-point lever on a second mast arm segment or on the turntable.

The invention relates to a mast arm for a large-scale manipulator, wherein the mast arm has a turntable which is rotatable about a vertical axis and a plurality of mast arm segments, wherein the mast arm segments are pivotable at articulated joints in each case about articulation axes relative to an adjacent mast arm segment or the turntable by means of one drive unit in each case, wherein at least one of the drive units is fastened to a first mast arm segment and acts via a lever mechanism on a second mast arm segment or on the turntable, wherein the lever mechanism comprises at least one two-point lever.

Mast arms for large-scale manipulators are known from the prior art. Such mast arms comprise at least two mast arm segments, which are pivotable at articulated joints about in each case horizontal articulation axes relative to an adjacent mast arm segment by means of one drive element in each case, in particular by means of a hydraulic cylinder, in particular in limited manner between a folded-in position and an operating position.

The demands made in terms of the reach of large-scale manipulators are continuing to grow. Since however the dimensions and/or the weight of the large-scale manipulators may not simply exceed certain limits due to legal regulations, it requires particular consideration in order to meet the greater demands in terms of range without contravening legal requirements in doing so.

Large-scale manipulators, in particular truck-mounted concrete pumps, in which the mast arm segments, which are connected to each other in an articulated manner, are connected with one another by means of lever geometries so that they can be folded in or folded out relative to each other are known from the prior art. In this case, as a rule a hydraulic cylinder acts on the mast arm segments via deflecting levers. As a rule, the levers are designed as straight rods. In the case of truck-mounted concrete pumps, provision may be made for the concrete delivery line to be laid through the articulated joints. Then the levers are often designed bent, in order to prevent a collision between the deflecting lever and the concrete delivery line when the mast arm segments are moved. The known deflecting levers however as a whole have the problem that they have a very high dead weight due to the large loads which are to be transmitted and due to their curved shape.

For this reason, WO 2016/078706 A1 proposes providing depressions or recesses in the two-point levers. However, the depressions or recesses do not increase the buckling strength. In order to increase the buckling strength, the levers would have to be made thicker, which increases their weight.

It is therefore the object of the invention to provide a mast arm of the type mentioned above which meets the growing demands made on the reach of large-scale manipulators, without being accompanied by adverse effects in another respect. In particular, the weight and/or the mass of the mast arm relative to the reach of the mast should be reduced, without reducing the buckling strength of the two-point lever.

This object is achieved by a mast arm having the features of claim 1, and by a large-scale manipulator having the features of claim 10.

Owing to the fact that the two-point lever encloses at least one cavity, a saving in weight can be achieved without reducing the buckling strength of the two-point lever. Due to the cavity in the two-point lever, at the same time the external dimension can be slightly increased, as a result of which the second moment of area, i.e. the buckling strength, of the lever increases while the weight remains the same. On the other hand, as a result the weight of the two-point lever can be reduced without adversely affecting the buckling strength. The two-point levers on the mast arm segments are subjected to high tensile and compression forces. In particular owing to the compression load and the resulting risk of buckling, the two-point levers as a rule are made very wide and thus are of great weight. A two-point lever which during operation of the mast arm is pivoted far from the turntable therefore produces a high load moment on the large-scale manipulator, which entails the risk of the entire machine tilting. In order to prevent this, in turn large supporting widths on the vehicle frame are necessary, which restricts the setting-up of the vehicle or large-scale manipulator at the deployment site. With a two-point lever which is made hollow, a saving in weight can be achieved which even with a low wall thickness of the two-point lever surrounding the cavity ensures great buckling strength under compression loads and reduces necessary supporting widths.

Particularly if the maximum acting compression load on the two-point lever is significantly greater than the maximum acting tensile force, a considerable saving in weight can be achieved by a two-point lever which is made hollow. The wall thickness of the hollow two-point lever has to be adapted to the maximum acting tensile force, since in the case of a tensile load the cross-sectional area of the two-point lever between the tension points is crucial.

Advantageous configurations and developments of the invention will become apparent from the dependent claims. It should be pointed out that the features listed individually in the claims may also be combined with one another in any technologically reasonable manner whatsoever and thus reveal further configurations of the invention.

According to an advantageous configuration of the invention, provision is made for the two-point lever to be assembled from a plurality of components, with the assembled components forming the cavity. The assembling of a plurality of components to form a two-point lever permits simple formation of a weight-saving cavity in the two-point lever. The components of the two-point lever may be connected together by means of a welding process.

The embodiment that the two-point lever has at least two bearing points, with the cavity being formed in a portion between the bearing points, is particularly advantageous.

The bearing points of the two-point lever are preferably formed by bearing rings or bearing eyes, through which in each case a pin extends and mounts the two-point lever rotatably on the mast arm segment, deflecting lever or turntable. Between these bearing points there is formed in the two-point lever a cavity-forming portion, which forms the weight-saving cavity. Owing to the fact that the cavity is formed between the bearing points, the bearing points themselves are of sufficient dimensions to absorb tensile and compression forces. The bearing rings or bearing eyes forming the bearing points to this end are preferably designed as solid steel rings.

One particularly advantageous embodiment of the invention provides for the cavity-forming portion to be designed as a tube. Such a tube, which is usually rolled, but also drawn or welded, may have a round or angular cross-section. A tube as a cavity-forming portion between the bearing rings or bearing eyes means that it is possible for weld seams for forming the two-point lever to be necessary merely between the tube and the bearing rings or bearing eyes, so that the weak points in particular for tensile loads on the two-point lever are limited.

It is particularly advantageous, in accordance with one configuration, for the cavity-forming portion to have at least one cavity-forming cut-out portion. The cavity-forming portion may also have a burnt-out portion, in which material is burnt out of a component of the two-point lever to form the cavity. Forming the cavity by cutting-out or burning-out is a simple way of reducing the weight of the two-point lever by a cavity which can be specified in a geometrically precise manner.

One advantageous embodiment is that the cavity-forming portion has at least one cavity-forming bore. With the formation of a cavity by one or more bores formed in the two-point lever, the weight of the two-point lever can be reduced in a simple manner without adversely affecting the buckling strength. By precise and suitable arrangement of the cavity-forming bore, weight can be saved on the two-point lever in a targeted manner.

The embodiment that the cavity-forming portion comprises welded-on metal side plates is particularly advantageous. Welding-on metal side plates in the cavity-forming portion increases the buckling strength of the two-point lever under compression load due to reinforcement on the outer edges of the two-point lever.

A particularly advantageous embodiment of the invention provides for the welded-on metal side plates to be designed to be continuous beyond the at least two bearing points. Owing to the fact that the welded-on metal side plates project beyond the bearing points, in particular the bearing rings or bearing eyes, these are connected together by a contiguous, rolled layer of material. Advantageously, areas of welding are provided for connecting the metal side plates to the bearing rings or bearing eyes of the bearing points.

It is particularly advantageous, in accordance with one configuration, for the cavity-forming portion to be formed from welded-together metal plates. By welding metal plates, a cavity-forming portion can be produced very simply and inexpensively. In this case, preferably a box profile made from four metal plates placed against one another, which are connected together by means of weld seams, is produced.

Further, the invention relates to a large-scale manipulator which has a mast arm already described above and described in greater detail below.

Further features, details and advantages of the invention will become apparent on the basis of the following description and with reference to the drawings. of the invention are illustrated purely schematically in the drawings below and will be described in greater detail below. Items which correspond to each other are provided with the same reference numerals in all the figures. The Figures show in:

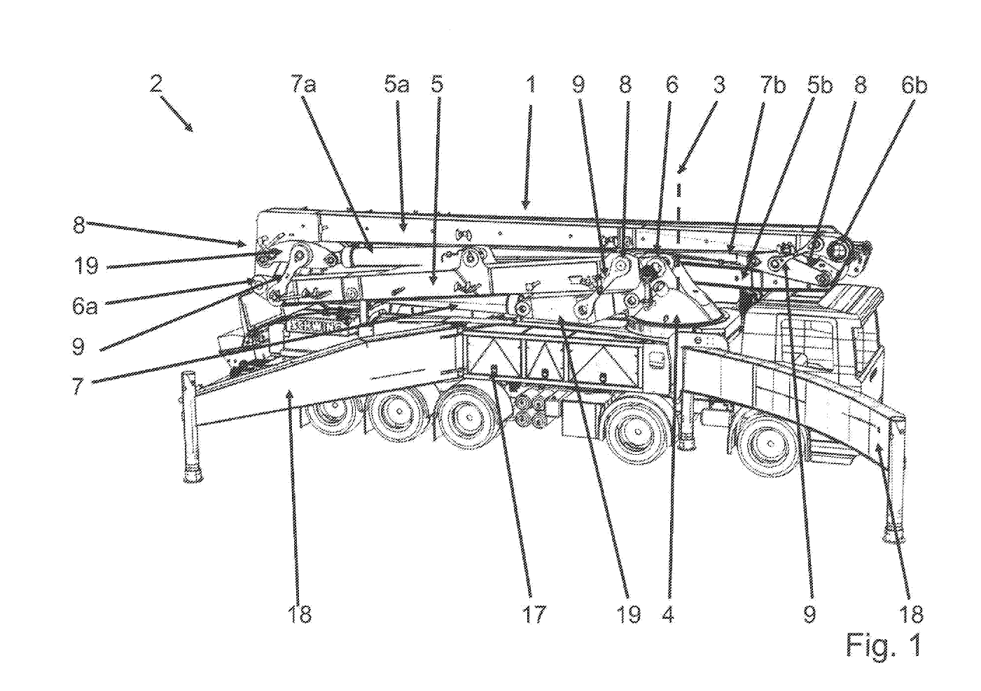

FIG. 1 a large-scale manipulator according to the invention,

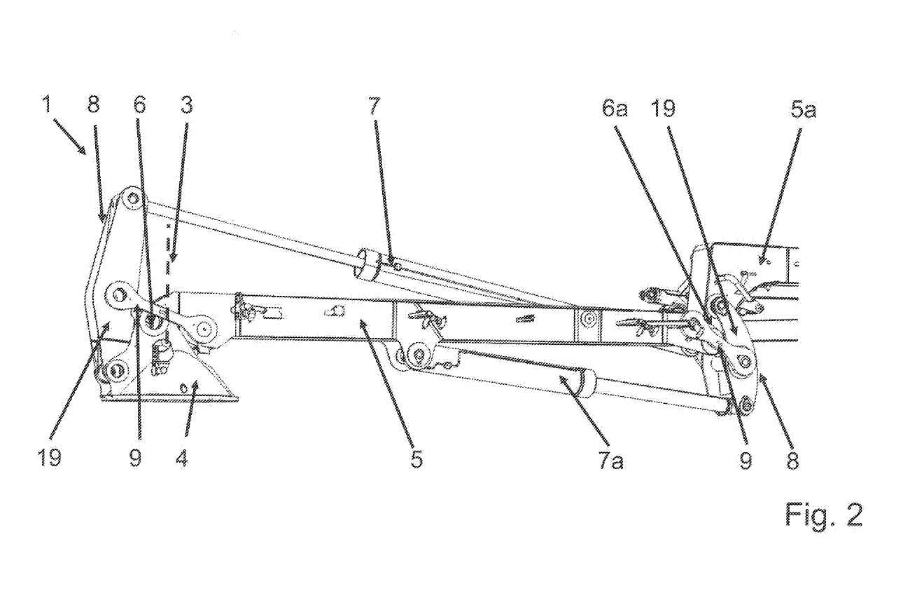

FIG. 2 a mast arm according to the invention,

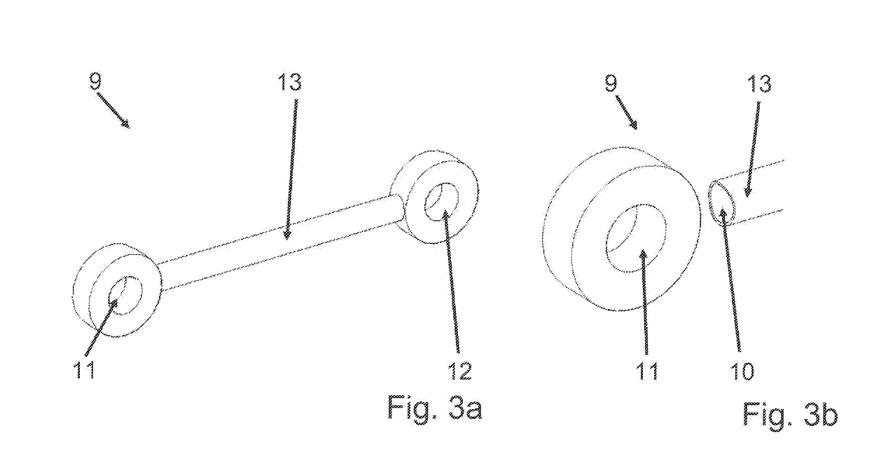

FIG. 3a, 3b a two-point lever according to the invention made from a round tube,

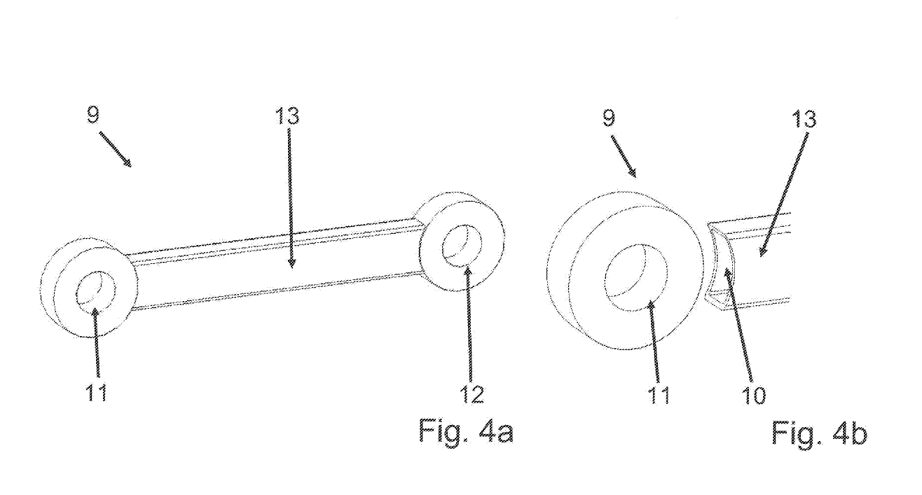

FIG. 4a, 4b a two-point lever according to the invention made from a rectangular tube,

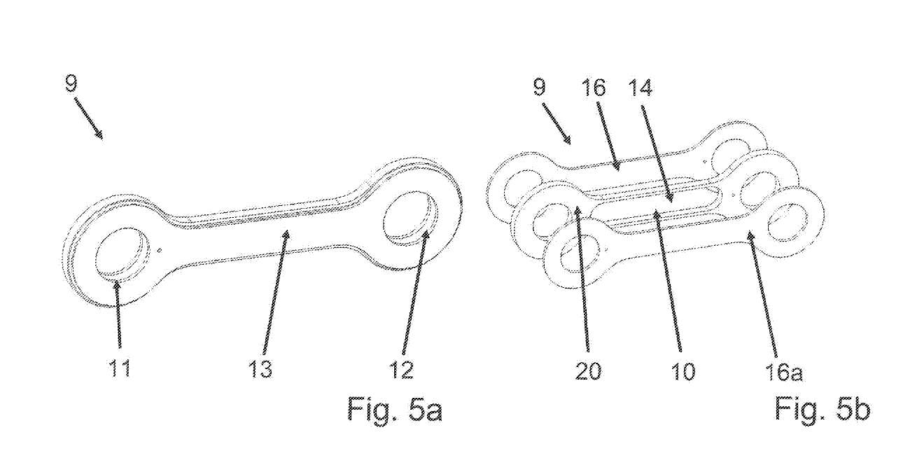

FIG. 5a, 5b a two-point lever according to the invention made from a plurality of welded components,

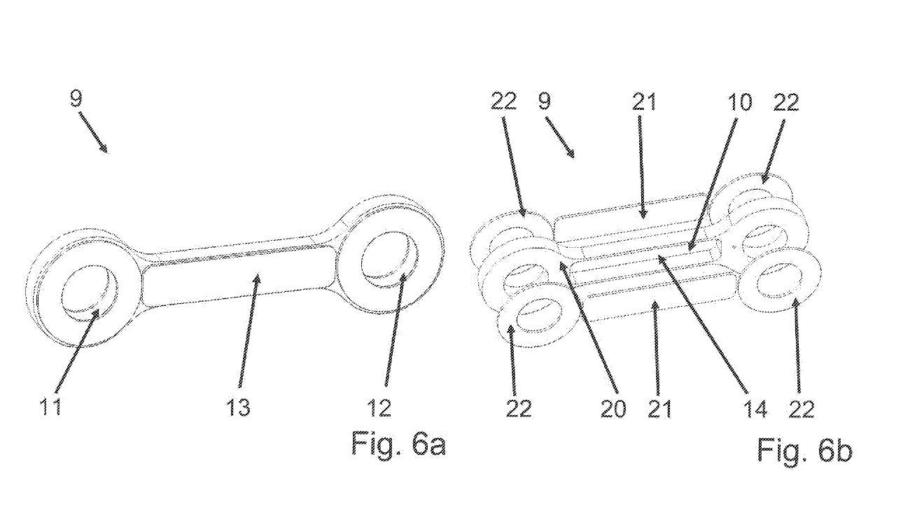

FIG. 6a, 6b a two-point lever according to the invention made from a plurality of welded components,

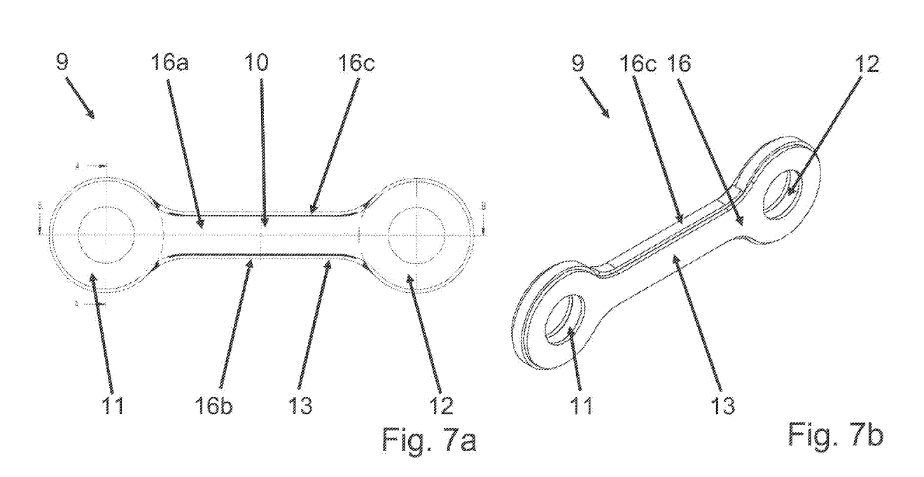

FIG. 7a, 7b a two-point lever according to the invention made from a plurality of welded components,

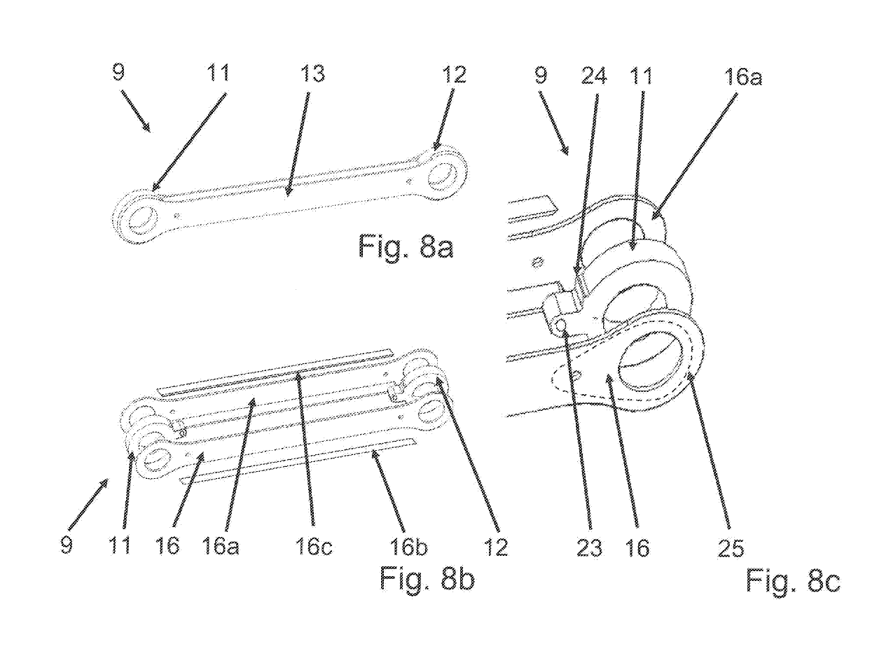

FIG. 8a, 8b a two-point lever according to the invention made from a plurality of welded components,

FIG. 8c a detail view of two-point lever made from a plurality of welded components,

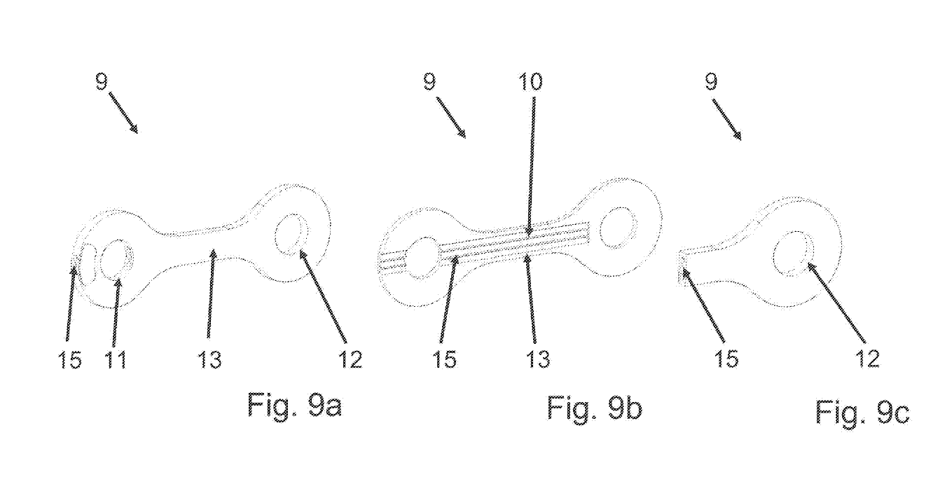

FIG. 9a, 9b, 9c a two-point lever according to the invention with bore,

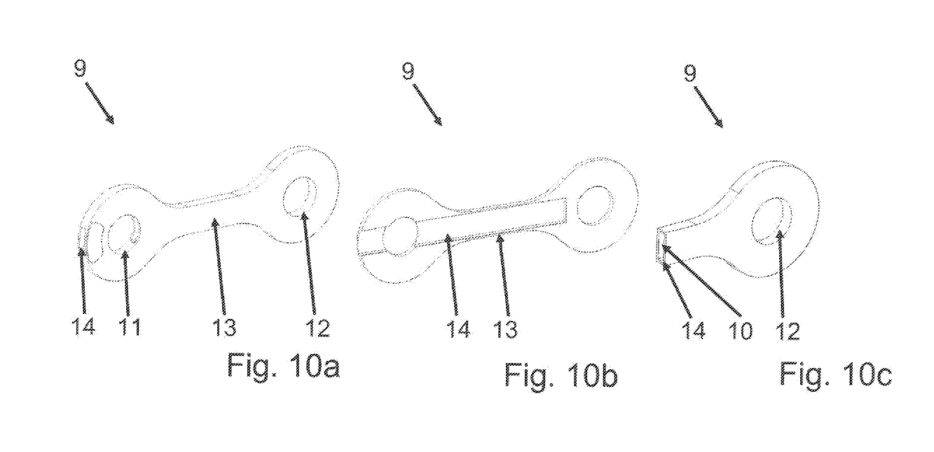

FIG. 10a, 10b a two-point lever according to the invention with cut-out portion,

FIG. 10c a detail view of two-point lever with cut-out portion,

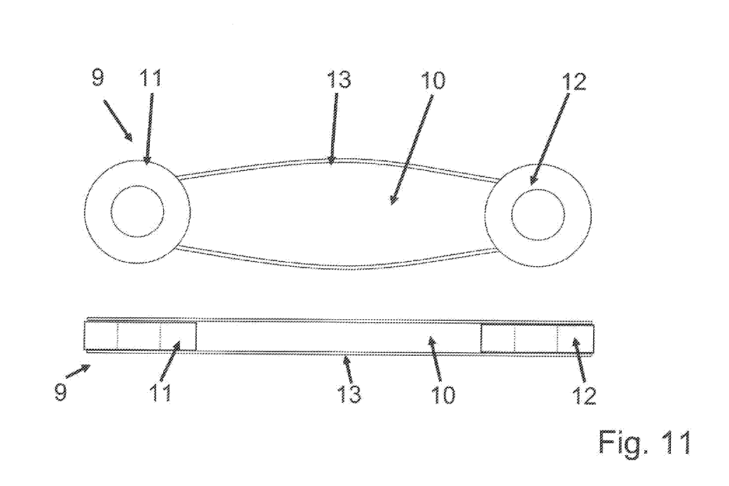

FIG. 11 a two-point lever according to the invention with buckling load in the plane of the lever,

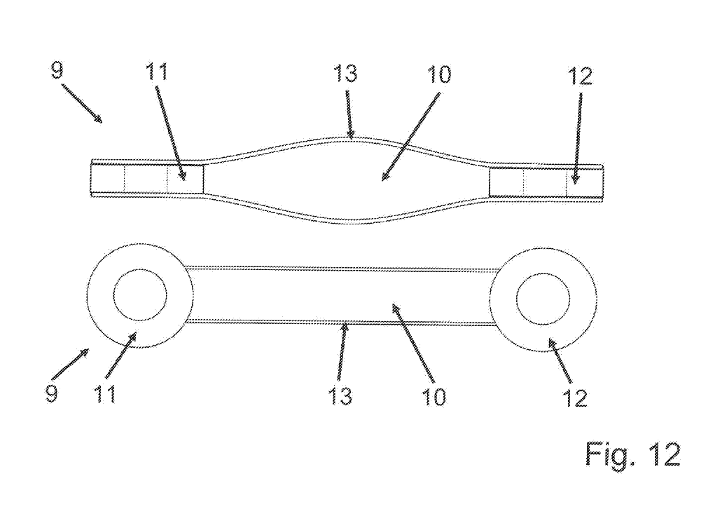

FIG. 12 a two-point lever according to the invention with buckling load perpendicular to the plane of the lever.

A mast arm according to the invention is illustrated in the figures, designated by the reference numeral 1. The mast arm 1 is illustrated in FIG. 1 mounted on a large-scale manipulator 2. The illustration according to FIG. 1 shows a large-scale manipulator 2 with a mast arm 1, which has a turntable 4 which is rotatable about a vertical axis 3, and a plurality of mast arm segments 5, 5a, 5b. The mast arm segments 5, 5a, 5b can be pivoted by means of articulated joints 6, 6a, 6b in each case about articulation axes relative to an adjacent mast arm segment 5, 5a, 5b or the turntable 4 by means of one drive unit 7, 7a, 7b in each case. In the illustration shown, the mast arm 1 is illustrated folded up, so that the large-scale manipulator 2, which is designed as a vehicle, can travel through the road traffic to the deployment site. On folding out the mast arm 1, a tilting moment is produced which is supported by means of the fold-out and extendable supports 18 arranged on the vehicle frame 17. To fold the mast arm 1 in and out, the drive units 7, 7a, 7b are fastened to the mast arm segments 5, 5a, 5b and act via lever mechanisms 8 on a different mast arm segment 5, 5a, 5b or the turntable 4. To this end, the lever mechanisms 8 have at least one two-point lever 9. On the first articulated joint 6 there is shown a two-point lever 9, which is subjected to a high tensile load at the beginning of the folding-out operation. The two-point lever 9 shown is mounted via pins on the first mast arm segment 5 and on the deflecting lever 19, on which the first drive unit 7 acts. The further articulated joints 6a, 6b, too, comprise lever mechanisms 8 on which two-point levers 9 are provided, in order to transmit tensile and compression forces between the mast arm segment 5 and the deflecting lever 19 on the drive unit 7a, 7b upon the folding-in and folding-out operation of the mast arm 1.

FIG. 2 shows a schematic view of a mast arm 1 according to the invention in one embodiment. The mast arm 1 has a first 5 and a second 5a mast arm segment, which are pivotable at an articulated joint 6a about a horizontal articulation axis relative to the adjacent mast arm segment 5, 5a by means of a drive unit 7, 7a. The drive unit 7a, which is preferably a hydraulic cylinder, is fastened to the first mast arm segment 5 and acts on the second mast arm segment 5a via a lever mechanism 8. The lever mechanism 8 preferably has two levers, with one lever being designed as a two-point lever 9 and the other lever as a deflecting lever 19. Also between the first mast arm segment 5 and the turntable 4 there is provided a lever mechanism 8 on which the first drive unit 7 acts. The lever mechanism 8 arranged on the first articulated joint 6 has in addition to the deflecting lever 19 likewise a two-point lever 9, which in the mast arm position shown is subjected to the maximum pressure, since the first drive unit 7 exerts a high tensile load on the deflecting lever 19 at the first articulated joint 6 in the position shown. In the position shown, the two-point lever 9 at the second articulated joint 6a is pivoted by the mast arm 1 such that the weight of the two-point lever 9 exerts a large load moment on the turntable 4. By reducing the weight at the two-point lever 9, the load moment exerted by the two-point lever 9 in the position shown can be reduced, so that the supports 18 (FIG. 1) need to be extended less far in order to prevent toppling of the large-scale manipulator 2 (FIG. 1). The supports 18 (FIG. 1) can thus also be made shorter. This furthermore makes the setting-up of the large-scale manipulator (FIG. 1) at the deployment site more flexible, since a lesser supporting width is necessary in order to support the large-scale manipulator 2 securely.

FIG. 3a shows a schematic view of a two-point lever 9 according to the invention in a first configuration. A two-point lever 9 of this type, but also the two-point levers described below, can be used in a lever mechanism 8 (FIGS. 1 and 2) of a mast arm 1 (FIGS. 1 and 2) and there save weight and reduce the load moment which is exerted by the weight of the two-point levers 9 on the turntable 4. FIG. 3a shows a two-point lever 9 which is assembled from a plurality of components in order to form a cavity 10.

The assembled components are two bearing rings which form the bearing points 11, 12 of the two-point lever 9. Through these bearing rings 11, 12 there is passed in each case a hinge pin in order to mount the two-point lever 9 rotatably on the deflecting lever 19 (FIGS. 1 and 2) and the mast arm segment 5, 5a, 5b (FIGS. 1 and 2) or turntable 4. Between the bearing rings 11, 12 there is formed a portion 13 which consists of a for example rolled round tube. This round tube 13 forms a cavity 10 which can be seen in FIG. 3b. By welding the bearing rings 11, 12 to the round tube 13, the two-point lever 9 is assembled from the components 11, 12, 13, as shown in FIG. 3a. This produces a two-point lever 9 which is simple to produce and offers a considerable reduction in weight compared with conventional two-point levers 9.

FIG. 4a shows a further configuration of a two-point lever 9 made of a for example rolled tube 13. The portion 13 between the bearing rings, which form the bearing points 11, 12, is formed by a rectangular tube 13 in the example of embodiment shown here. It can be seen in FIG. 4b that the rectangular tube 13 forms a cavity 10 between the two bearing points 11, 12. This means that a considerable reduction in weight can be achieved, with in particular the rectangular cross-sectional contour of the rolled tube 13 being particularly suitable for ensuring sufficient buckling strength for compression loads, since the second moment of area of the lever 9 is increased by the enlarged external dimensions. In the example of embodiment shown here too, the tube 13 is connected to the further components, or to the bearing rings 11, 12 of the two-point lever 9, preferably by means of welded joins.

FIG. 5a shows a further configuration of the two-point lever 9 according to the invention. In the example shown here too, the two-point lever 9 is assembled from a plurality of components, with the assembled components forming the cavity 10. In one of the components 20, a cavity-forming cut-out portion 14 is provided in the portion 13 forming the cavity 10. The cavity 10 may for example also be produced by burning out material from the component 20. It can be seen in FIG. 5a that the one-part middle component 20 of the two-point lever 9 has a corresponding cavity-forming cut-out portion 14 or burnt-out portion 14. The cavity-forming portion 13 furthermore comprises welded-on metal side plates 16, 16a, which are shown separately in FIG. 5b. The metal side plates 16, 16a are designed to be continuous beyond the bearing points 11, 12 and as a result offer additional stability for the two-point lever 9 thus formed. To produce the two-point lever 9 shown in FIG. 5a, the metal side plates 16, 16a are welded onto the middle component 20, so that the cavity-forming cut-out portion 14 is covered by the metal side plates 16, 16a. The metal side plates 16, 16a increase the buckling strength of the two-point lever 9.

FIG. 6a shows a two-point lever 9 according to the invention in a further configuration. Here too, a middle component 20 is provided which has a cavity-forming cut-out portion 14 or burnt-out portion 14 in the region of the cavity-forming portion 13 between the bearing points 11, 12, as can also be seen in FIG. 6b. The metal side plates 16 welded onto the middle component 20 are of multi-part construction and have a crosspiece 21, and sheet metal rings 22 covering the bearing rings 11, 12. Covering the metal side plates 21, 22 increases the buckling strength of the two-point lever 9 and prevents corrosion in the cavity-forming cut-out portion 14 or burnt-out portion 14.

The two-point lever 9 shown in FIGS. 7a and 7b also has a cavity 10, by which the two-point lever 9 makes a considerable saving in weight compared with levers of solid material. As can be seen from the sectional view according to FIG. 7a, the two-point lever 9 shown here is assembled from a plurality of components 11, 12, 16, 16a, 16b, 16c, the components 11, 12, 16, 16a, 16b, 16c when assembled enclosing a cavity 10 which is formed in a portion 13 between the bearing points 11, 12. The cavity-forming portion 13 is formed from welded-together metal plates 16, 16a, 16b, 16c. The cavity-forming portion 13 has welded-on metal side plates 16, 16a, which are designed to be continuous beyond the at least two bearing points 11, 12. As a result, the bearing rings 11, 12 which form the bearing points 11, 12 are encompassed by the welded-in metal side plates 16, 16a, as a result of which a stable and buckling-resistant two-point lever 9 of reduced dead weight is produced.

FIGS. 8a and 8b show a two-point lever 9 which is likewise assembled from a plurality of components 11, 12, 16, 16a, 16b, 16c, with the components 11, 12, 16, 16a, 16b, 16c together forming a cavity 10 which is formed in a portion 13 between the bearing points 11, 12. The cavity-forming portion 13 has welded-on metal side plates 16, 16a, which are designed to be continuous beyond the at least two bearing points 11, 12. As a result, the bearing rings 11, 12 which form the bearing points 11, 12 are encompassed by the welded-in metal side plates 16, 16a. Furthermore, the cavity-forming portion 13 comprises further metal plates 16b, 16c, which are welded together with the metal side plates 16, 16a to form an edge profile, in order to form the cavity 10. Additionally, the bearing rings 11, 12 of the bearing points 11, 12 have a projection 23 for screw connection of the anti-twist protection means of the hinge pin (not shown) which is received in the bearing rings 11, 12. This anti-twist protection means is illustrated in greater detail in FIG. 8c. Here it can be recognized that the bearing ring 12 has a further projection 24 for positioning and for weld pool backing. Furthermore, an anti-twist protection means 25 for the pin is indicated in broken lines. The further bearing ring 11 is also configured correspondingly.

FIGS. 9a, 9b and 9c show a two-point lever 9 according to the invention, with a cavity 10 being formed in a portion 13 between the bearing points 11, 12, in that a plurality of cavity-forming bores 15 are provided in the portion 13. These bores 13 which are formed can be seen very clearly in the sectional views in accordance with FIGS. 9b and 9c and run between the two bearing points 11, 12 along the cavity-forming portion 13.

FIGS. 10a, 10b and 10c show a two-point lever 9 according to the invention, with here too a cavity 10 being formed in a portion 13 between the bearing points 11, 12, with a cut-out portion 14 being provided to this end in the cavity-forming portion 13. This cut-out portion 14 which is formed can be seen very clearly in the sectional views in accordance with FIGS. 10b and 10c and runs between the two bearing points 11, 12 along the cavity-forming portion 13.

The illustration according to FIG. 11 shows a two-point lever 9 according to the invention, which is designed in particular for a buckling load in the plane of the lever.

Owing to the shaping of the lever 9, in particular of the cavity-forming portion 13, the lever 9 is particularly adapted to its buckled figure, so that the lever 9 can optimally absorb a buckling load in the plane of the lever with the minimum use of material. In this case, the two-point lever 9 acts like a buckling column in accordance with Euler mode 2.

The illustration according to FIG. 12 shows a two-point lever 9 according to the invention, which is designed in particular for a buckling load perpendicular to the plane of the lever. The description for FIG. 11 applies accordingly. In this case, the two-point lever 9 acts like a buckling column in accordance with Euler mode 4.

### LIST OF REFERENCE NUMERALS

### List of Reference Characters

1 mast arm
2 large-scale manipulator
3 vertical axis
4 turntable
5 5a 5b mast arm segments
6 6a 6b articulated joints
7 7a 7b drive units
8 lever mechanism
9 two-point lever
10 cavity
11 bearing point A
12 bearing point B
13 cavity-forming portion
14 cut-out portion, burnt-out portion
15 bore
16 16a metal side plates, 16b 16c further metal plates
17 vehicle frame
18 supports
19 deflecting lever
20 middle component
21 crosspiece
22 sheet metal rings
23 projection (anti-twist protection means)
24 projection (weld pool backing)
25 anti-twist protection means

1-10. (canceled)

11. A mast arm for a large-scale manipulator, the mast arm comprising:
a turntable rotatable about a vertical axis;
a two-point lever enclosing at least one cavity; and
a plurality of mast arm segments including a first mast arm segment and a second mast arm segment, the plurality of mast arm segments pivotable at articulated joints about articulation axes relative to an adjacent mast arm segment or the turntable via a respective drive unit,
wherein at least one of the respective drive units is fastened to the first mast arm segment and acts, via the two-point lever, on the second mast arm segment or on the turntable.

12. The mast arm of claim 11, wherein the two-point lever is assembled from a plurality of components, wherein the assembled components form the cavity.

13. The mast arm of claim 11, wherein the two-point lever includes at least two bearing points, wherein the cavity is formed in a portion between the bearing points.

14. The mast arm of claim 13, wherein the portion includes a tube.

15. The mast arm of claim 13, wherein the portion includes at least one cut-out portion.

16. The mast arm of claim 13, wherein the portion includes at least one bore.

17. The mast arm of claim 13, wherein the portion includes welded-on metal side plates.

18. The mast arm of claim 17, wherein the welded-on metal side plates extend beyond the at least two bearing points.

19. The mast arm of claim 13, wherein the portion is formed from welded-together metal.

20. A large-scale manipulator comprising:
a mast arm including:
a turntable rotatable about a vertical axis,
a two-point lever enclosing at least one cavity, and
a plurality of mast arm segments including a first mast arm segment and a second mast arm segment, the plurality of mast arm segments pivotable at articulated joints about articulation axes relative to an adjacent mast arm segment or the turntable via a respective drive unit,
wherein at least one of the respective drive units is fastened to the first mast arm segment and acts, via the two-point lever, on the second mast arm segment or on the turntable.

21. The mast arm of claim 20, wherein the two-point lever is assembled from a plurality of components, wherein the assembled components form the cavity.

22. The mast arm of claim 20, wherein the two-point lever includes at least two bearing points, wherein the cavity is formed in a portion between the bearing points.

23. The mast arm of claim 22, wherein the portion includes a tube.

24. The mast arm of claim 22, wherein the portion includes at least one cut-out portion.

25. The mast arm of claim 22, wherein the portion includes at least one bore.

26. The mast arm of claim 22, wherein the portion includes welded-on metal side plates.

27. The mast arm of claim 26, wherein the welded-on metal side plates extend beyond the at least two bearing points.

28. The mast arm of claim 22, wherein the portion is formed from welded-together metal.
